(19) United States
(12) Patent Application Publication
(10) Pub. No.: US 2024/0071010 A1
(43) Pub. Date: Feb. 29, 2024

(54) MECHANISMS FOR RECOGNITION OF OBJECTS AND MATERIALS IN AUGMENTED REALITY APPLICATIONS

(71) Applicant: LabLightAR Inc., Seattle, WA (US)

(72) Inventors: Roger BRENT, Seattle, WA (US); William PERIA, Shoreline, WA (US); Gabriella E. LABAZZO, Seattle, WA (US); William LAI, Bellevue, WA (US); Stacia R. ENGEL, Woodbridge, CA (US); Karrington OGANS, Seattle, WA (US)

(21) Appl. No.: 18/240,641

(22) Filed: Aug. 31, 2023

Related U.S. Application Data
(60) Provisional application No. 63/374,198, filed on Aug. 31, 2022.

(51) Int. Cl. G06T 19/00; G06T 3/40; G06T 5/00; G06V 10/774; G06V 20/70

(52) U.S. Cl. CPC G06T 19/006; G06T 3/40; G06T 5/002; G06V 10/774; G06V 20/70; G06T 2207/20084; G06V 2201/07

(57) ABSTRACT

Training sets of images used for training machine vision systems for object recognition may be augmented via various training set augmentation methods. The machine vision systems trained via the augmented training sets may be further used in an augmented reality procedural guidance system for guiding an operator to complete one or more steps with respect to one or more objects. The training set augmentations may include one or more of an object motion augmentation, a camera motion augmentation, an object herding or clumping augmentation, an object size reduction augmentation, a diversified background augmentation, and a diversified background augmentation with synthetic background images. In some instances, machine vision systems may also be alternatively or concurrently trained to use optically distinguishable markers to recognize objects.

### CROSS-REFERENCE TO RELATED PATENT APPLICATION

This application claims priority to U.S. Provisional Patent Application No. 63/374,198, filed on Aug. 31, 2022, entitled “Mechanism for Recognition of Objects and Materials in Augmented Reality Applications,” which is hereby incorporated by reference in its entirety.

### BACKGROUND

A number of factors make it challenging to use machine learning methods for the identification of objects in augmented reality applications. These include some of the same factors that make it difficult to identify objects using deterministic methods. These include difficulty distinguishing differences in dimensions and shape among small objects or objects far from the camera, and difficulty in distinguishing among three-dimensional objects in two-dimensional image data due to differences in pose.

Trained neural networks at present are typically unable to distinguish among (classify) very large numbers (e.g., 10,000s) of different object types. To become useful at recognizing objects, neural networks typically require the application of training sets comprising large numbers of different images of the same objects and/or types of objects. In each of these images, images of the object (pixels corresponding to the object) must be distinguished (segmented) from the rest of the image, and object images must be associated with labels that function as classifiers. It is difficult to generate large amounts of such training data specific to objects in particular environments, such as laboratories or workplaces.

Images used in training sets may be subject to systematic biases (for example in the background of the image that is not part of the object) so that networks trained on these images are not able to correctly classify objects in images with backgrounds different from those present in the training data. It is difficult to generate large amounts of training data not subject to such biases.

Images comprising labeled and segmented objects used in training sets preferably do not comprise background pixels corresponding to unlabeled, un-segmented objects that are present as labeled objects in other images in the training data. Training of a network on such mixed, partly unlabeled training data may result in a trained network that cannot recognize objects it has trained on when those objects occur in contexts similar to that in images in which the objects were unlabeled. It is difficult to obtain or generate large amounts of training data not subject to this negative effect.

To implement machine vision and augmented reality systems that can identify and interpret objects, materials, relationships, and actions in the work environment, there is an urgent need to overcome these shortcomings.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts an embodiment of an environment of interest 102.

FIG. 2 depicts an augmented reality system 200 in accordance with one embodiment.

FIG. 3 depicts an augmented reality system in one embodiment.

FIG. 4 depicts a process for generating a neural network training set in accordance with one embodiment.

FIG. 5A-FIG. 5C depict aspects of image segmentation, image annotation, and training set formation in accordance with one embodiment.

FIG. 6 depicts a transformation pipeline for generating training set augmentations.

FIG. 7A depicts an example of an image 702 comprising a sub-image of an object 704 and a bounding box 706 of the object 704.

FIG. 7B depicts the image 702 after undergoing a shrinker image augmentation 602 followed by a clumping image augmentation 604.

FIG. 8A-FIG. 8C depict example embodiments of optically distinguishable markers.

FIG. 9 depicts a machine 900 by which a set of instructions may be executed for causing the machine to perform any one or more of the methodologies discussed herein, according to an example embodiment.

### DETAILED DESCRIPTION

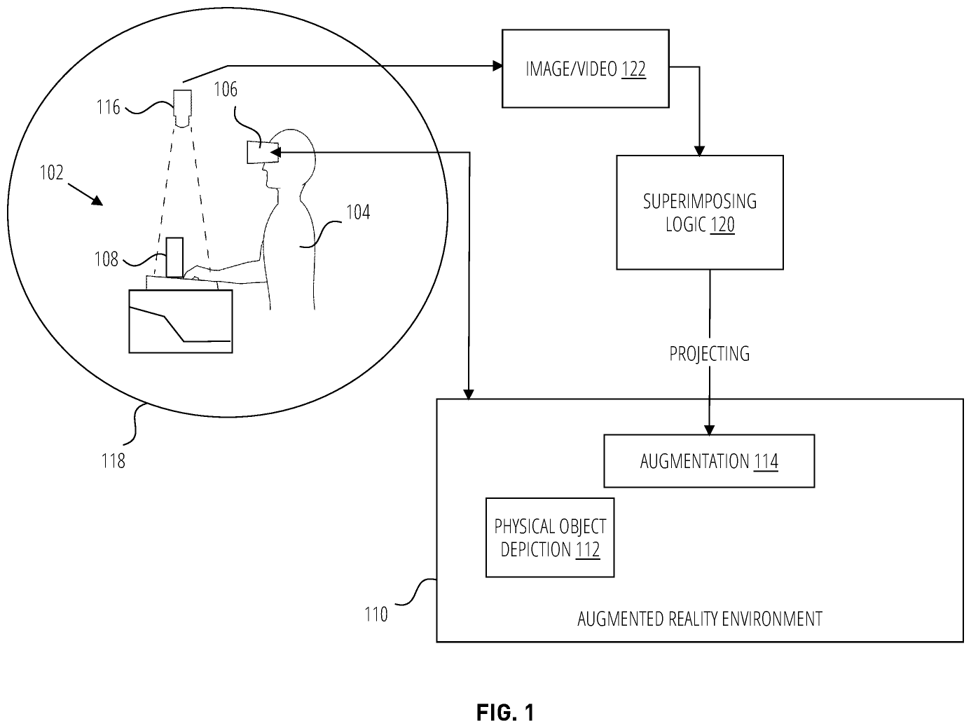

FIG. 1 depicts an embodiment of an augmented reality system utilized for procedural guidance in an environment of interest 102. A human operator 104 (there may be more than one) wearing an augmented reality headset 106 interacts with one or more physical objects 108 and/or virtual objects in the augmented reality environment 110 according to a computer-aided procedure. In this example the human operator 104 interacts with a physical object 108 on a lab bench or other structure. The physical object 108 may be depicted in the augmented reality environment 110 (as physical object depiction 112) along with or replaced by an augmentation 114. The augmentation 114 may represent the entire physical object 108 and/or may depict augmenting information such as controls, settings, instructions, and so on for interacting with the physical object 108 (e.g., arrows, attention cues, look here cues, cues showing two or more objects are associated, cues warning of unsafe condition or imminent errors). The computer-aided procedure may provide open- or closed-loop operator guidance. Virtual objects and/or sounds may also be projected into the augmented reality environment 110.

An optional augmented camera 116 is directed to capture images or video of the physical workspace 118 of the environment of interest 102 from its visual field (field-of-view). The augmented camera 116 may be one or more fixed position cameras, or one or more moveable cameras, or a combination of fixed position cameras and moveable cameras. Superimposing logic 120 (which may be implemented in one or more of the augmented camera 116, augmented reality headset 106, or an auxiliary computing system) transforms the images or video 122 into a depiction in the augmented reality environment 110.

By way of example, the augmented reality environment 110 may depict the physical object 108 augmented with virtual content or may depict both the physical object 108 and the augmentation 114 as a combined virtualized depiction.

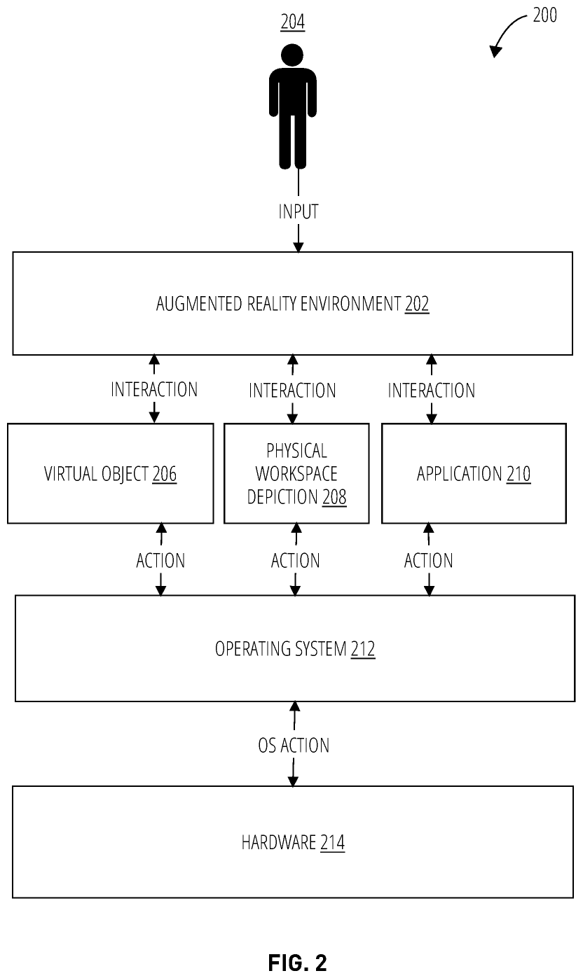

FIG. 2 depicts an augmented reality system 200 in accordance with one embodiment. The augmented reality environment 202 receives input from the operator 204 and in response sends an interaction signal to a virtual object 206 (which may be a composite of virtual information and the physical object depiction 112, a physical workspace depiction 208, or an application 210. The virtual object 206 or physical workspace depiction 208 or application 210 sends an action to an operating system 212 and in response, the operating system 212 operates the hardware 214 (e.g., an augmented reality headset) causing the software running on the headset to implement or direct the action in the augmented reality environment 202. As described, this action by the procedure or application that the software on the AR device is running can include actions that direct the operator to perform a task or induce the operator to take an action or to take particular actions based on feedback from the operator from the operator's input or actions (“closed-loop” control).

“Application” refers to any logic that is executed on a device above a level of the operating system. An application may typically be loaded by the operating system for execution and make function calls to the operating system for lower-level services. An application often has a user interface but this is not always the case. Therefore, the term ‘application’ includes background processes that execute at a higher level than the operating system. A particularly important kind of application that the device runs is those applications that are “protocols” or “procedures”, or enable the device to “run” these. Protocols and procedures are applications providing procedural guidance, which can be open- or closed-loop, that guides the operator in the performance of particular tasks.

“Operating system” refers to logic, typically software, that supports a device's basic functions, such as scheduling tasks, managing files, executing applications, and interacting with peripheral devices. In normal parlance, an application is said to execute “above” the operating system, meaning that the operating system is necessary in order to load and execute the application and the application relies on modules of the operating system in most cases, not vice-versa. The operating system also typically intermediates between applications and drivers. Drivers are said to execute “below” the operating system because they intermediate between the operating system and hardware components or peripheral devices.

“Instructions” refers to symbols representing commands for execution by a device using a processor, microprocessor, controller, interpreter, or other programmable logic. Broadly, ‘instructions’ can mean source code, object code, and executable code. ‘Instructions’ herein is also meant to include commands embodied in programmable read-only memories (EPROM) or hardcoded into hardware (e.g., ‘micro-code’) and like implementations wherein the instructions are configured into a machine memory or other hardware component at manufacturing time of a device.

“Logic” refers to any set of one or more components configured to implement functionality in a machine. Logic includes machine memories configured with instructions that when executed by a machine processor cause the machine to carry out specified functionality; discrete or integrated circuits configured to carry out the specified functionality, and machine/device/computer storage media configured with instructions that when executed by a machine processor cause the machine to carry out specified functionality. Logic specifically excludes software per se, signal media, and transmission media.

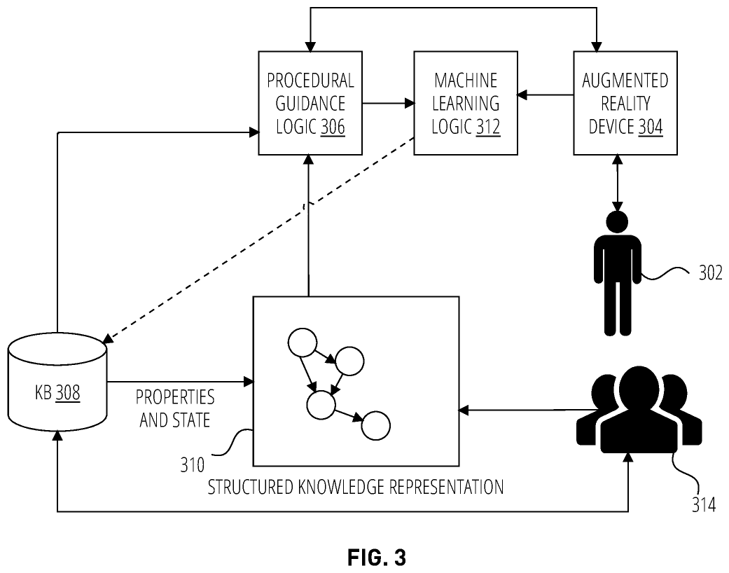

FIG. 3 depicts an augmented reality system in one embodiment. The system comprises a human operator 302 utilizing an augmented reality device 304 with sensory augmentations generated by procedural guidance logic 306. The procedural guidance logic 306 utilizes a knowledge base 308 and a structured knowledge representation 310 such as an ontology, JSON dictionary, or rules engine or any combination thereof, to generate the augmentations. The knowledge base 308 comprises any of object, material, substance, procedure, environment, and equipment properties and characteristics (e.g., metadata tags such as SKUs, serial numbers, etc.) and their relationships to the structured knowledge representation 310. Throughout, it should be understood that “properties” refers to one or both of properties and characteristics, unless indicated otherwise by context. The knowledge base 308 may be augmented/updated by machine learning logic 312, trainers 314, or both. The structured knowledge representation 310 in this embodiment may be augmented by one or more human trainers 314.

The knowledge base 308 and the structured knowledge representation 310 are complementary systems for organizing settings utilized by the procedural guidance logic 306 to control renderings by the augmented reality device 304. In the knowledge base 308, settings may be organized with table structure and ‘references’ (to other tables). If the structured knowledge representation 310 comprises an ontology, settings may be organized by applying ‘terms’ and ‘relations’. The structured knowledge representation 310 may be part of a database, or may be accessed independently. The amount of overlap between the two information sub-systems is customizable based on how the overall augmented reality system is designed. At one extreme (no overlap between structured knowledge representation 310 and knowledge base 308 (i.e., no knowledge base 308)), the system may function in autonomous mode, driven only from settings in the structured knowledge representation 310. At the other extreme (complete overlap between structured knowledge representation 310 and knowledge base 308 (i.e., structured knowledge representation 310 stored completely in knowledge base 308)), the knowledge base 308 overall may comprise all settings and data points regarding protocol activity. This ‘complete overlap’ mode may be especially advantageous for downstream machine learning capabilities and applications. Considering these two extremes and the range of options between them, there is a subset of queries that may be carried out with access to the structured knowledge representation 310 alone, without having to access a knowledge base 308. This ‘lite package’ or configuration operates with a ‘genetic operator’, with the headset in ‘autonomous’ mode, not connected to an active database but instead fully-contained and mobile. The augmented reality device 304 operates in an autonomous mode providing instruction but does not collect data.

The knowledge base 308 comprises properties and characteristics about objects, materials, operations etc. in the work environment that the computational moiety (procedural guidance logic 306) of the human-in-the-loop AR guidance system utilizes. The knowledge base 308 provides the procedural guidance logic 306 and the human operator 302 structured settings from closed sources or local repositories.

In one embodiment the knowledge base 308 is implemented as a relational database structured as tables and data objects, with defined relations between them which enable identification and access to properties in relation to other properties. The properties in the knowledgebase may be organized around a ‘protocol’ as the main object type (a “protocol-centric relational database”). The knowledge base 308 is organized to enable successful completion of specific protocols, and thus may provision settings (the aforementioned properties) for protocols, their required materials, authorized operators, and so on. The knowledge base 308 may be queried using the programming language SQL (Structured Query Language) to access the property tables. In one embodiment the open-source PostgreSQL relational database management system (aka database engine) is utilized for creation, updating, and maintenance of the knowledge base 308.

The knowledge base 308 comprises distinct settings for various protocols and the steps therein, including context in which certain protocols are performed as well as their intended use, and required machinery, reagents, tools, and supplies. This includes knowledge, for example, of servicing, storage requirements, and use-by dates about specific objects, such as items of equipment and materials.

For objects, the knowledge base 308 may comprise additional properties including but not limited to their overall dimensions, their particular three-dimensional shapes (including those defined by standard CAD/CAM datatypes), and other distinguishable optical characteristics such as surface color, albedo, and texture, which in turn can be used to define keypoints. Specific objects may be associated with masses and other properties which need not arise from direct observation, such as object classes, manufacturer, model numbers, SKU numbers, published information about their use in particular procedures, images and videos describing their operation, country of origin, transportation history/chain of possession/provenance, expert knowledge about the specific object or model, or class of object, ranking in comparisons with other specific objects, metrics of customer satisfaction, comments and annotations by expert users.

Object properties may further comprise object dimensions and features visible under different imaging modalities such as depth properties, hyperspectral visual properties, infra-red properties, non-electromagnetic properties, and properties not accessible by direct observation.

For consumable reagents and supplies used in regulated processes, relevant properties may comprise the manufacturer, the vendor, the SKU/product number, the number of entities in the package (e.g., Pack of 10), the product's official name, sub information typically appended to the official name, (e.g., “Solution in DMSO, 10×100 μL”), storage instructions (particularly including temperature range), expiration or use-by date, country of manufacture and other alphanumeric information on bar codes and QR codes.

Entities may be represented in the knowledge base 308 as members of one or more classes. Specific objects, substances and materials differ in the object classes to which they belong. For example, culture tubes may be members of the class “tube” and also typically members of the class of “glassware” or “plasticware”, and may be members of the larger class of “objects found in labs” (as opposed to vehicle maintenance facilities). This membership in multiple classes can be formally represented by Directed Acyclic Graphs (DAGs). The knowledge base 308 may additionally comprise learned knowledge such as collected information regarding protocol activity—which operators carried out what protocols at what point in time, protocol status (e.g., completed or paused or exited), protocol outcome, etc.

The knowledge base 308 enables the procedural guidance logic 306 of the human-in-the-loop AR procedural guidance system by codifying the necessary entity properties in computable form, thereby providing a fast, easy, and reliable method for supporting both structured queries to answer specific questions about objects, their relations to other objects, and related protocols. In addition to enabling the procedural guidance logic 306, the knowledge base 308 enables direct queries by the human operator 302, for example by voice request after the word “provenance” or “customer reviews”. Query-driven navigation of the knowledge base 308 is aided by specific terms in the associated structured knowledge representation 310.

Although depicted and described herein as a system supporting human operator 302 use of an augmented reality device 304 for procedural guidance, it may be readily apparent that the knowledge base 308 and structured knowledge representation 310 may be utilized by automated or robotic systems, or mixed systems comprised of humans and robots. Learning accumulated in the knowledge base 308 by the machine learning logic 312 over the course of using the procedural guidance system (such as common points operators make errors), e.g., encoded in annotation tables, may be applied to improve the performance of the system on future protocols.

The system also utilizes the structured knowledge representation 310 to enable operation of a human-in-the-loop AR interactive procedural guidance system. In one aspect, the structured knowledge representation 310 enables operation of the procedural guidance logic 306 by providing a query-friendly structure for relevant knowledge including knowledge in the knowledge base 308. Enabling procedural guidance systems to understand the environment or workspace from camera images may also require encoding in software our knowledge of particular objects such as the 96-well plate example above. To enable this capability, detected objects in a scene may be represented by software instances of a general class, a class which might be called DetectedObject, with properties and methods common to all objects, or by instances of specialized classes built on the general class, e.g. MicroPipette, with additional properties and methods peculiar to micropipettes. When the machine vision system detects a physical object, the augmented reality system creates an instance of the corresponding specialized class if one exists (based on the label delivered by the neural network), or else defaults to creating an instance of the general class. Such instances can compute useful properties of their corresponding physical objects using the object's mask (i.e. the pixels comprising its image, as also delivered by the neural network). The general class has methods such as computing the centroid and the principal axes of object masks; the specific classes have methods that are peculiar to their corresponding objects. For example, an instance of the MicroPipette class can compute whether or not the barrel of the pipetter it represents currently bears a sterile tip. Specialized object instances might make queries of the user, or, regarding the proper use of the objects they represent, might generate and display instructions, or query an ontology to ensure proper workspace conditions, or add conditions to a list that the system regularly requests be checked. Software instances with these capabilities might be called “Smart Objects”, by which we mean to say that specialized knowledge, needed to deliver procedural guidance involving their corresponding physical objects, is encapsulated in their code; the AR system in charge of delivering the guidance does not have or need this specialized knowledge. Smart Objects might consist of code that computes important aspects of the state of their physical objects, or might know how to compute such things by accessing an ontology or knowledge base. The point is, such computations are encapsulated in the code of Smart Objects; the AR system can remain agnostic or even ignorant about them. In another aspect, the structured knowledge representation 310 may enable the human operator 302 to apply queries to interact with the knowledge base 308 and the structured knowledge representation 310. Queries may be structured by the operator in a way that reflects the logical organization of the structured knowledge representation 310, or not (i.e., the structured knowledge representation 310 may be navigated by search). As the structured knowledge representation 310 grows, it embodies more and more knowledge that scholars and workers may utilize to their benefit.

As the system provides procedural guidance and the human operator 302 and the system transition from step to step, the procedural guidance logic 306 may draw settings and properties from the structured knowledge representation 310 and the knowledge base 308. The structured knowledge representation 310 in conjunction with properties obtained from the knowledge base 308 enable the procedural guidance system to ‘understand’ what it is seeing via its sensors and to guide the human operator 302 on what to do next, or to detect when the human operator 302 is about to make an error. To aid in understanding, queries from the procedural guidance logic 306 are handled by the structured knowledge representation 310. These queries are typically a consequence of the system running interactive procedural content, and frequently draw on knowledge in the knowledge base 308 (for example, associated information about a given material might indicate that it is explosive).

The ontology portion of the structured knowledge representation 310 encodes concepts (immaterial entities), terms (material entities), and relationships (relations) useful for the description of protocols and processes and guidance for their execution. In biotechnology and biopharma, processes can include lab bench protocols and also procedures requiring operation and maintenance of particular items of equipment such as cell sorting instruments, fermentors, isolation chambers, and filtration devices. The ontology portion of the structured knowledge representation 310 enables the description the procedures and processes as pathways, or ‘activity models’, comprising a collection of connected, complex statements in a structured, scalable, computable manner.

The structured knowledge representation 310 encodes concepts (immaterial entities), terms (material entities), and relationships (relations) for the description of protocols, procedures, and/or processes and guidance for their execution. The ontology portion of the structured knowledge representation 310 enables the description of each of these as pathways, or ‘activity models’, comprising a collection of connected, complex statements in a structured, scalable, computable manner. Herein, it should be understood that a reference to any of protocols, procedures, or processes refers to some or all of these, unless otherwise indicated by context.

The structured knowledge representation 310 comprises a computational structure for entities relevant to sets of protocols. These entities include both material and immaterial objects. Material entities include required machinery, reagents and other materials, as well as authorized human operators. Immaterial objects include the protocols themselves, the steps therein, specific operations, their ordinality, contexts in which specific protocols are performed, timing of events, corrective actions for errors, and necessary relations used for describing how these material and immaterial entities interact with or relate to one another. The structured knowledge representation 310 encodes in a structured and computable manner the different protocols, materials, and actions (‘codified’ or ‘known’ settings), and supports the performance of protocols by facilitating the recording (in the knowledge base 308) of data points regarding execution and outcome of protocols (state information and ‘collected’ or ‘learned’ settings). Execution and outcome results may in one embodiment be encoded using annotation tables to support the use of machine learning logic 312 in the system.

In one embodiment the ontology portion of the structured knowledge representation 310 is implemented as structured settings representing material entities (embodied in the set of object_terms), immaterial entities (concepts), and the relationships (relations) between them, with the potential to enumerate the universe of possible actions performed in protocols. A formalism of the temporal modeling enabled by the ontology portion of the structured knowledge representation 310 represents protocols as structured, computable combinations of steps, materials, timing, and relations. The structured knowledge representation 310 encodes protocol settings for specific work environments for the performance of protocols, procedures, tasks, and projects.

Procedures encoded in the structured knowledge representation 310 each include one or more tasks/steps, and these tasks/steps may be associated with certain dimensions, properties, and allowable actions. Some of these dimensions and properties are enumerated as follows.

Revocability. If an action of a step is misapplied, can it be repeated, or does this deviation destroy or degrade the process such that a restart is required? Properties to characterize this dimension of a procedural step may include revocable, irrevocable, can_repeat_step, must_start_from_beginning. The meaning of these properties is evident from the naming.

Self-contained-ness. May a step, for example a repair_step, be carried out with resources (people and materials) inside a facility, or need it rely on outside inputs (e.g., scheduled visit of repair people)? Properties to characterize this dimension of a procedural step may include fixable_in_house or needs_outside_talent. In a relational DAG encoding, fixable_in_house may be related to what's_wrong, and what's_wrong may have relations including how_does_it_usually_fail? and how_do_we_fix_it?

Other important dimensions for protocols, procedures, processes, and even projects include those along a temporal and/or causal axis. This including ordinality, temporality, cause and effect, and dependency.

Ordinality. What is the order of this step? What comes before it, what after it? Examples include precedes_step.

Temporality. When does a particular step occur or need to occur in clock time? How long is it likely to be before the protocol or process can be completed? Examples include elapsed_time and time_to_finish.

Cause and effect. This dimension may be useful for troubleshooting and analysis of failures. One property characterizing this dimension is frequent_suspect.

An object may fail (break), a process_step may fail (not yield starting material or state for the next configured step), and an operation may fail (to be performed properly). A reagent or kit may fail (for reasons described by terms such as become_contaminated or expire). These entities may be configured with a property such as failure_prone, delicate or fragile, robust, or foolproof. Objects may be characterized by quantitative values including mean_time_to_failure and in some cases use_by_date or service_by_date.

There are also general ways an operator can fail (typically, by dropping or breaking or contaminating). An operator may be characterized by a property such a klutz or have_golden_hands.

The entire protocol or process may fail because of failures in objects, process steps, or operations, and also because process steps and operations were performed out of sequence or without satisfying necessary dependency relationships. A process_step may be nominal, suboptimal, and in some embodiments, superoptimal, and the outcome of a process may be nominal, suboptimal, or failed. An entire protocol or process may fail, defined as failure to generate results or products that satisfy acceptance_criteria. When that happens, the structured knowledge representation 310 in conjunction with the knowledge base 308 may enable interrogation of the temporal model to identify suspected points of failure and reference to a recording of the performed process to identify certain kinds of failures such as out_of_sequence operations.

Dependency. Is a designated step (e.g., a protocol step) dependent on one or more previous steps, and if so, how? Examples include:
finish_to_start. (step B can't start until previous step A has finished).
finish_to_finish (step B can't finish before previous step A finishes)
start_to_start (step B can't start until previous step A starts)
start_to_finish (step B can't finish until step A starts)

As noted previously, the structured knowledge representation 310 supports the computational moiety (procedural guidance logic 306) of the human-in-the-loop AR procedural guidance system by codifying the necessary knowledge (about procedure, materials, and workplace) in computable form, thereby providing a fast, easy, and reliable method for supporting both structured and spontaneous queries to answer specific questions about objects, their relations to other objects, related protocols, and their execution.

This computability supports novel and particularly useful functions. These include but are not limited to recognizing whether conditions (materials and objects and relations) to carry out a particular procedure exist, recognition of correct human operator 302 completion of a step, provision of the human operator 302 with action cues for next actions, communication to the human operator 302 of error conditions that might correspond to safety hazards or allow the operator to avert imminent errors, provision of the human operator 302 with additional context-appropriate knowledge pertinent to objects, materials, and actions, and warning the human operator 302 of imminent errors.

For example, for protocols requiring cleanliness or sterility, pipet_tip_point on lab_bench is an error condition. Another example is recognizing that a 50 mL_tube is_moved_to a 50 mL_tube_rack might mark completion of a step. This recognition might cause cause the procedural guidance system to offer up the next action cue. Another example involves a protocol in which having pipet_tip_point in well_A3 of a 96_well_plate might marks successful step completion, while placing the pipet_tip_point into well_A4 might be an error condition. Recognition that the pipet_tip_point was over the wrong well would allow the system to warn the operator and allow the operator to avert the imminent error.

Another dimension of procedures encoded in the structured knowledge representation 310 is resilience, the capability to work the procedure around absences, differences, or shortages of materials and objects and being able to execute the process successfully within constraints (for example, time, quality or regulatory constraints).

Resilience also characterizes the capability to work around temporal disruptions (e.g., due to power outages or late arrival of materials), including disruptions that affect the time needed to complete a step, or to successfully execute a process or task. To represent resilience to such disruptions, the structured knowledge representation 310 may utilize expiration dates and relationships pertinent to temporality and/or causality that are encoded for objects/materials in the knowledge base 308, including revocable/irreversible, ordinality, and dependency relationships. For example, a key material needed for production step two of a procedure may expire in two weeks. However step two may be initiated at a time/date such that in twelve days from its initiation it may be completed, the procedure paused, and step three then initiated on schedule.

The knowledge base 308/structured knowledge representation 310 duality may also be utilized to directly aid the human operator 302 carry out process steps. For example, the human operator 302 may voice hands-free commands for help/instruction or to navigate the knowledge base 308 or structured knowledge representation 310 (“tell me more”, “down”, “up”, and “drill”). The knowledge base 308/structured knowledge representation 310 may enable the query of sequences of presentations authored by others (e.g., “tour”, which tells the operator the next important thing some author thought the operator should know). A map may be displayed by the augmented reality device 304 depicting where the human operator 302 is in the knowledge base 308/structured knowledge representation 310. Voice commands may also activate hypertext links (“jump”) and search functions.

One challenge in developing a procedural guidance system based on machine vision systems is the lack of pertinent training set data to train neural networks to understand the work environment of interest. Existing training sets (e.g. “COCO” (Common Objects in Context—Lin et al. 2014) do not comprise images of specialized objects found, for example, in GMP production suites or for MD assays for COVID-19. Nor do they present objects in the (often cluttered) environment contexts in which those objects are found and used.

To enable more efficient and accurate procedural guidance systems based on machine vision, a need exists for training sets comprising images of objects utilized in particular procedural tasks in situ with backgrounds likely to be encountered in those environments. A training set comprises a curated set of images and image annotations for training (configuring via learning) a machine learning algorithm such as a neural network. Image annotations may comprise the names of objects in the image and/or notations about relationships among the objects.

An example network to be trained is YOLACT (Bolya et al. 2019). This is a fully convolutional neural network that carries out real-time instance segmentation. A trained instance of YOLACT identifies objects, tags each identified object with an object label and a confidence score for the label, places a mask over the object, and draws a bounding box around the object (FIG. 1). The label represents the highest confidence object class scored by the network. The confidence score describes (from 0.0 to 1.0) how confident the network is that the identified object is correct. The mask is comprised of the contiguous pixels in an image that correspond to an identified object; the program gives pixels corresponding to different objects distinct colors. The program also draws a rectangular bounding box surrounding the mask.

An example training set for utilization with machine vision systems for procedural guidance in laboratory environments is TDS12. TDS12 comprises a collection of images of 37 lab different lab objects (eg. tubes, pipeting devices) used in the rRT-PCR protocol used to detect SARS-CoV-2 in patient specimens (CDC, 2020). TDS12 comprises 5321 images, which comprise a total of 9,614 annotated object instances. The images were captured using a diversity of digital cameras and from ARTEMIS's depth camera sensor, under different lighting conditions, against different backgrounds, and in the context of realistic laboratory settings. Some images comprise only a single object type, some included multiple objects.

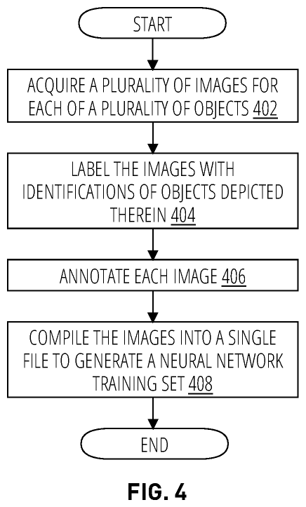

Creation of TDS12 and other training data sets follows a four step process: Image acquisition (FIG. 4, block 402), object labeling (FIG. 4, block 404), and compilation of additional information about each image, i.e., image annotation (FIG. 4, block 406), and putting all the annotated images into a single file to make the TDS (FIG. 4, block 408).

The first step is image acquisition. This is the process of capturing multiple pictures of each object using a variety of different cameras, different camera angles and distances from object, different lighting conditions, and different image backgrounds.

Key to this acquisition is the systematic attempt to maximize variety such that a small set of images may comprise examples of most of the different representative cameras, camera angles, distances from object, lighting conditions, and image backgrounds likely to be found in the environment to be understood by the machine vision system.

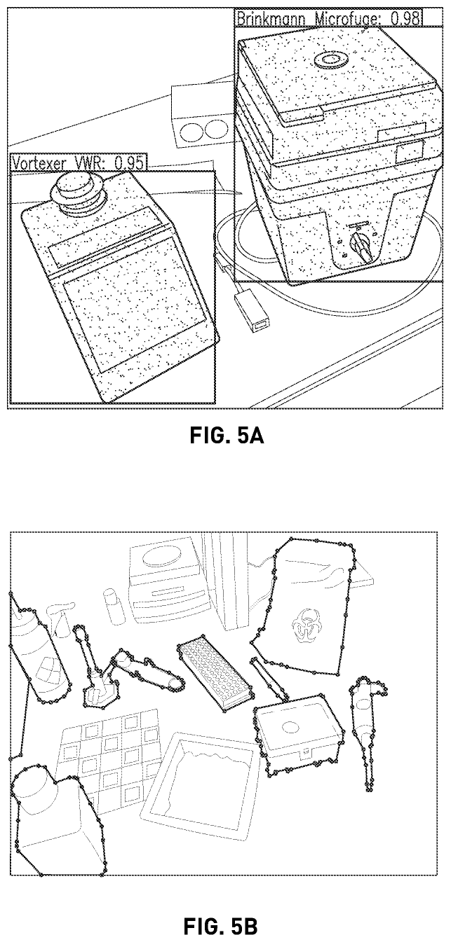

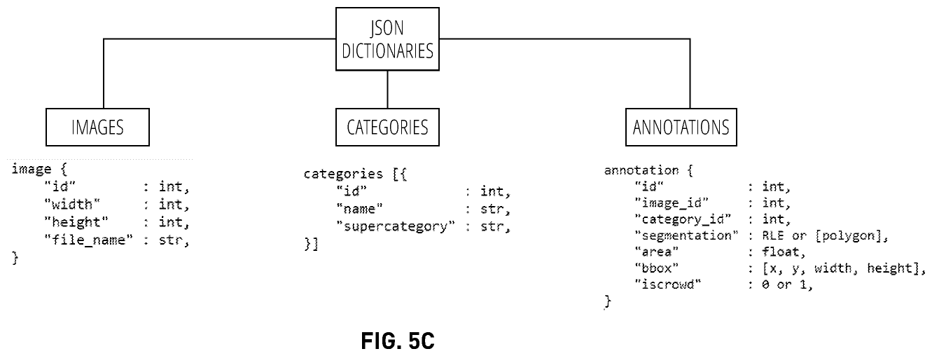

Object labeling is the next step. In this step, objects to be recognized in images are identified in the images and then segmented (separated, object from background). Human operators may identify the object and then carry out the image segmentation using for example a program called Labelme (Torralba et al.). The human operator labels the objects by clicking around each object as depicted for example in FIG. 5A to create a polygon whose perimeter corresponds to the boundaries of the object in the image. The interior of the polygon defines a “ground truth” mask, that defines the pixels in the image that correspond to a recognized object type, and so distinguishes those pixels from those that comprise the rest of the image. The position of this perimeter provides information to the location of the rectangular bounding box around each object (aka minimum bounding rectangle), defined as the maximum extent of the object within the (x, y) coordinate system of the image (e.g., min(x), max(x), and min(y), max(y)). To complete this step, the human operator attaches to the polygon a label corresponding to one of the object classifications for the machine vision system to recognize and distinguish.

In one embodiment, objects are associated with labels configured within a structured knowledge representation that enables the labels to be members of multiple object classes. For example, a label “culture tube”, attached to and segmented out of an image, might be represented in a structured knowledge representation of labels in which “culture tubes” were members of the class “tube” and also typically members of the class of “glassware” or “plasticware”, and are members of the larger class of “objects found in labs”. These structured knowledge representations are derived from expert knowledge and/or are based on expert assessment of the results of clustering or other machine learning methods. Structured knowledge representations may be structured as directed acyclic graphs (DAGs).

In the next step, image annotation, after the image is labeled, the labeler adds to the image file additional annotating information (annotations) about the object (FIG. 5B). Here, these include the vertices of the polygon drawn to segment the object from the image background.

In the fourth step, the images, annotations (labels) and additional image information are compiled into training set file (a single entry is shown in FIG. 5C). In one embodiment, this file is in JSON format.

The JSON file for the training set comprises information including the file name of each image, the category each labeled object in each image belongs to, and the location of the segmenting polygon for each labeled object in the image.

An ongoing fifth step of active curation of the training set may take place. Examples of active curation include correction of inaccurate labels and removal of duplicative images. Another example includes re-examination of the images in the training set to either remove, or to segment and label, object classes previously not recognized (e.g., to mitigate overtraining of the neural network).

In addition to the steps described above, the training set may undergo training set augmentation.

As used here, the term “training set augmentation” refers to methods that increase the effective size (number of members) of a training set by adding modified or semisynthetic instances of images already in the training set. For training on images, many such training set augmentations are possible. These include but are not limited to rotating the image by 90o, flipping the image horizontally and vertically, elastically deforming parts of the image, modifying the colors in the image, carrying out other photometric distortions, superimposing two images, blocking or erasing parts of the image, adding noise to or blurring parts of the image, and juxtaposing portions of multiple images to create a mosaic (Solowetz, J., 2020).

Training neural networks on limited amounts of image data in cluttered lab environments may benefit from novel training set augmentations having specific utility for recognition of objects in these environments of interest.

One such training set augmentation is referred to herein as the shrinker image augmentation. This training set augmentation inputs the labeled object and shrinks it within the boundaries of the image segment that it previously occupied. Vacated space filled using shrunken background image information. This augmentation has high utility for aiding recognition of objects of different apparent sizes, due for example to being recognized via headset cameras on augmented reality devices; it counteracts the natural tendency to collect training images in which the object of interest occupies an atypically large segment of the image.

Another such training set augmentation is referred to herein as the mover image augmentation. This training set augmentation inputs the pixels corresponding to the labeled object and blurs them as if the object was in motion during image exposure. This augmentation has particular utility for machine vision recognition of objects held in moving human hands (e.g., a sterile pipette tip in use).

Another such training set augmentation is referred to herein as the shaker image augmentation, which blurs the image pixels, as if the image for the training data was taken with a hand-held device such as a smartphone with a slowish exposure time (e.g., 1/15th second). This augmentation has particular utility for machine vision recognition of objects via cameras attached to moving humans (ie, on AR headsets).

Another such training set augmentation is referred to herein as the photobomb image augmentation, which takes the pixels corresponding to the labeled object and inserts the object into another image, often with background clutter. This augmentation has particular utility for training networks to recognize objects in backgrounds that differ in their objects that make up the background clutter; it counteracts the tendency to collect training data from images of objects of interest photographed in isolation on a clean background.

Another such training set augmentation is referred to herein as the synthetic photobomb image augmentation, which uses a 3D coordinate model (CAD/CAM) of an object to generate synthetic images of the object and applies game-like physics to place the object in physically realistic ways into backgrounds partly comprised of other objects that might be relevant to the synthetic object's context.

Another such training set augmentation is referred to herein as the clumping image augmentation, which inputs images of scattered objects and, by deleting non-object pixels, “herds” them into a tighter clump. Herding consists of first assigning the objects to a random sequence. The first object in the sequence, or “prime object”, does not move. Each successive object moves, one at a time, along the line that joins its centroid to the centroid of the prime object, until its convex hull makes contact with the convex hull of any preceding object.

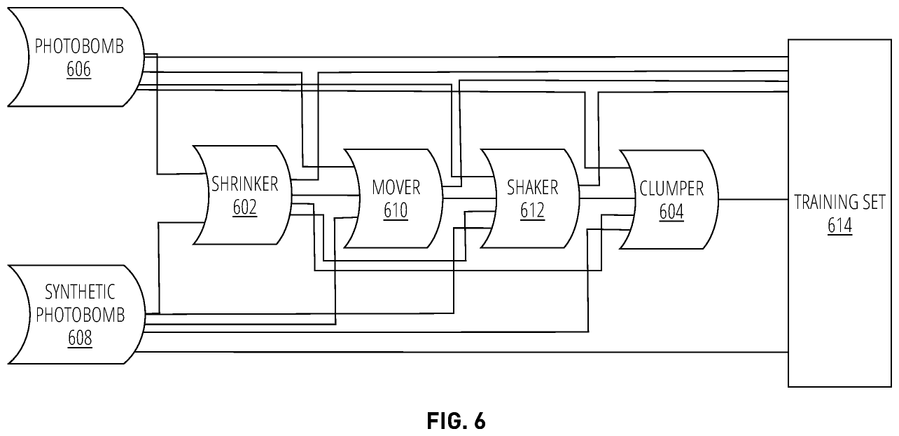

FIG. 6 depicts a transformation pipeline for generating training set augmentations. A photobomb image augmentation 606 and/or a synthetic photobomb image augmentation 608 generate training set augmentations comprising objects of interest in different background settings. These training set augmentations are input to a shrinker image augmentation 602, mover image augmentation 610, shaker image augmentation 612, and clumping image augmentation 604, each of which produces additional training set augmentations for storage in the training set 614. The training set augmentation from any prior stage in the production pipeline may be utilized as an input to any subsequent stage, resulting in compound training set augmentations being generated and saved in the training set 614. The output of any stage may also be saved directly in the training set 614.

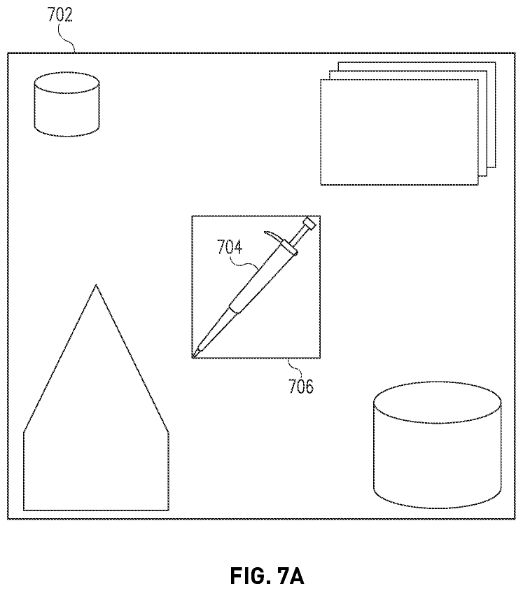

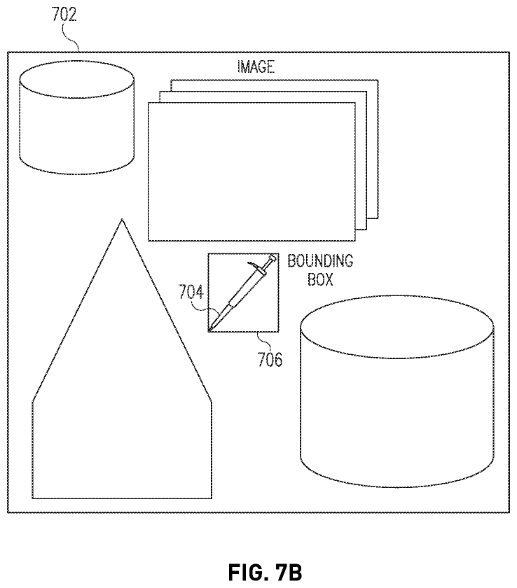

FIG. 7A depicts an example of an image 702 comprising a sub-image of an object 704 and a bounding box 706 of the object 704. The image 702 may be an un-augmented photo of an environment of interest, or may be the result of a photobomb image augmentation or synthetic photobomb image augmentation. FIG. 7B depicts the same image 702 after undergoing a shrinker image augmentation 602 followed by a clumping image augmentation 604.

Disclosed herein are optically distinguishable markers (such as symbols or glyphs) that may be distinguished by machine vision systems (e.g., those utilizing neural networks) that are pre-trained to classify them. The optically distinguishable markers may be associated with particular objects in a knowledge base 308 or structured knowledge representation 310 so that they may be recognized in an environment of interest such as a laboratory. The optically distinguishable markers may be affixed to particular objects via any variety of adhesive, glue, ink, paint or other pigment, magnet, silk-screening, laser-etching, or other manner of object-tagging.

Use of optically distinguishable markers may greatly magnify the ability of machine vision systems to distinguish small or transparent/semitransparent objects in particular.

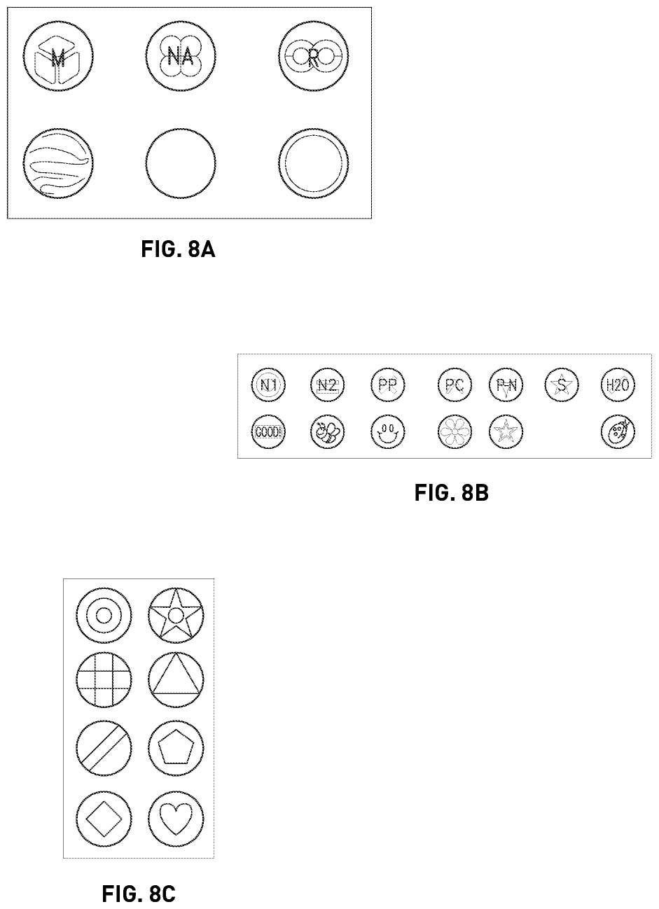

Example embodiments of optically distinguishable markers are depicted in FIG. 8A-FIG. 8C. In various embodiments the optically distinguishable markers utilize simple geometric shapes and bi- or tri-part color schemes (e.g., solid circles of single colors on solid backgrounds), human-recognizable icons (e.g., bumblebee and ladybug), and human-readable alphanumeric characters with high contrast to a background of reduced color saturation.

The optically distinguishable markers depicted may be embodied as stickers used to aid identification of objects and reagents to which they are affixed. The stickers are peeled from their backing and adhered to the objects to be recognized and distinguished. Row 1 of FIG. 8A and row 1 of FIG. 8B depict examples of optically distinguishable markers with human readable alphanumeric characters and combinations of colors and background patterns that deterministic systems can be programmed to recognize and neural networks can be trained to classify, and with hue and saturation reduced to increase legibility of the human readable characters.

Row 2 of FIG. 8A depicts optically distinguishable markers embodied as solid color stickers with corner reflectors, and row 2 of FIG. 8B depicts machine distinguishable stickers that may be utilized in environments of interest to children. FIG. 8C depicts additional examples of optically distinguishable markers conducive to machine vision algorithms.

Optically distinguishable markers conducive to machine vision algorithms may utilize combinations of colors (or even grayscale), textures, and patterns that generate strong distinctive boundaries in digital camera sensors over a range of different spectral distributions and intensities that characterize different kinds of natural and artificial light.

Unlike bar codes and QR codes, which are machine-readable markings that encode data (numbers, numbers and letters), the optically distinguishable markers do not encode data, but rather qualitatively distinguishable patterns and carry an inherent association with object types in a structured knowledge representation for an environment of interest.

Machine vision systems may be configured to recognize different optically distinguishable markers using non-perceptron based algorithms (e.g., heuristics), and perceptrons such as neural networks may be configured via training to correlate the different optically distinguishable markers to object classes.

In some embodiments, the optically distinguishable markers are adapted to be distinguished by machine visual systems outside the human readable spectrum, such as IR, US, terrahertz, etc.

In some embodiments, the optically distinguishable markers also contain human readable information such as alphanumeric characters. In some embodiments, the hues are chosen, and the saturation of machine-readable colored patterns is reduced, to increase the contrast with the human-readable characters (which may be presented in solid black) while enhancing the ability for machine vision systems to recognize the markers under different light conditions.

In some embodiments, the optically distinguishable markers may be paired with or placed onto an object that also carries a bar code or a QR code, so that the optically distinguishable marker recognized by the machine vision system is associated with the code and information encoded by the code.

Utilizing these mechanisms, a human operator may initiate a procedural sequence (for example unpacking and storing an incoming shipment of materials or preparing to carry out a laboratory procedure) by affixing particular optically distinguishable markers to particular objects.

In carrying out later procedural work, the human operator may utilize alphanumeric markings on the optically distinguishable markers to identify the different objects, while the machine vision system recognizes the optically distinguishable marker pattern and associates it with an object type in a structured knowledge representation.

In some embodiments, the optically distinguishable markers are utilized in augmented reality procedural guidance systems in conjunction with a structured knowledge representation in accordance with the embodiments described in U.S. Application No. 63/336,518, filed on Apr. 29, 2022.

In some systems, the optically distinguishable markers may be drawn, scratched, stenciled, or etched directly onto the associated objects.

In addition to stickers, optically distinguishable markers may be embodied in other types of detachable forms. Exemplary alternative embodiments include magnets that cling to ferromagnetic objects, and markings on artificial press-on fingernails, to allow the network to distinguish among an operator's fingers or finger-like end effectors.

Optically distinguishable markers may be generated using machine algorithms, such as generative neural networks. For example, adversarial neural networks used to develop images, markers, and patterns that humans can identify but machine vision systems cannot (e.g., those used in Captchas) may be repurposed to generate markers, images, etc. that machine vision systems may more readily distinguish.

As noted above, patterns in the form of glyphs recognizable by a trained neural network and used to distinguish objects, for example in a protocol, so as to control the operation of a human-in-the-loop augmented reality procedural guidance system, may be algorithmically generated utilizing generative neural networks.

It is known to the art that a Generative Adversarial Network (GAN), sometimes called “the forger”, can be trained to produce images that fool a second neural network (sometimes called the judge) into accepting them as (erroneously) belonging to some classification.

In one embodiment, we extend this concept to create Generative Cooperating Networks (GCNs) comprised of a generator network trained to generate different glyphs that a second judge network (such as one utilized in a procedural guidance system) is trained to recognize with high accuracy (for example against different backgrounds) and/or be steered in its generation to satisfy other criteria (for example, to generate glyphs that are also easily recognized and distinguished by humans, or to generate glyphs that are not easily distinguished and recognized by humans (the conceptual opposite of CAPTCHA images/glyphs).

Generative models have been composed from recurrent neural networks (RNNs), Variational Autoencoders (VAEs), and Generative Adversarial Networks (GANs) and may be combined with transfer learning or scoring against other criteria (eg. physicochemical properties to steer generative design. Urbina et al., “MegaSyn: Integrating Generative Molecule Design, Automated Analog Designer and Synthetic Viability Prediction”, ChemRxiv https://chemrxiv.org/engage/chemrxiv/article-details/61551803d1fc335b7cf8fd45, DOI 10.26434/chemrxiv-2021-nlwvs). Such steering is in general accomplished by customizing an appropriate objective function to be optimized during training

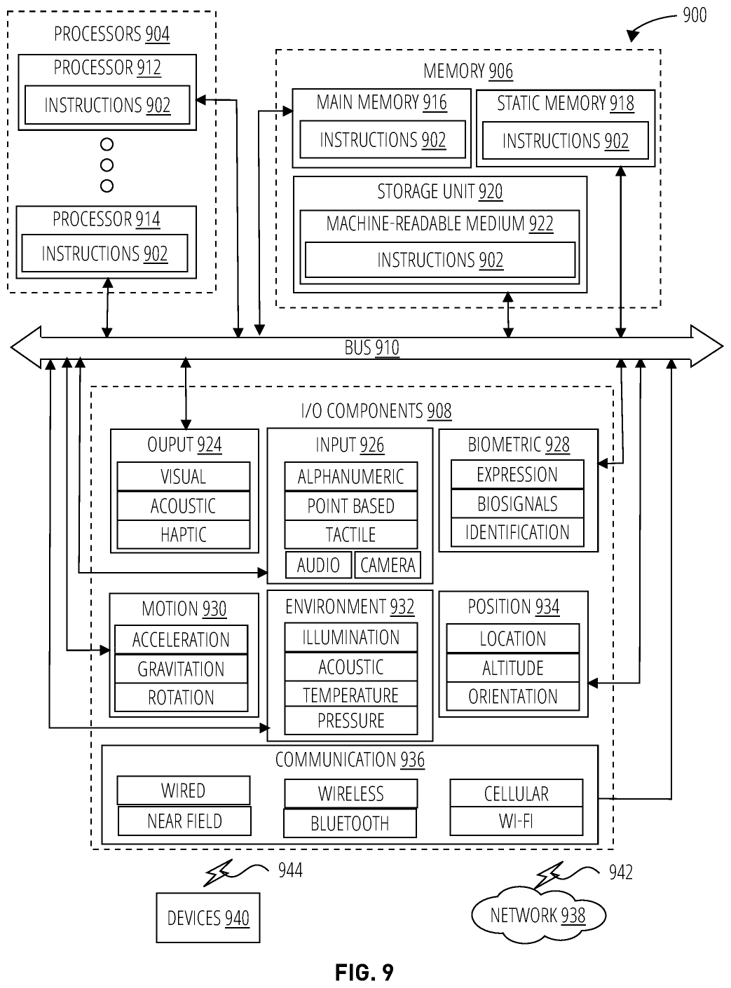

FIG. 9 depicts a diagrammatic representation of a machine 900 in the form of a computer system within which logic may be implemented to cause the machine to perform any one or more of the functions or methods disclosed herein, according to an example embodiment.

Specifically, FIG. 9 depicts a machine 900 comprising instructions 902 (e.g., a program, an application, an applet, an app, or other executable code) for causing the machine 900 to perform any one or more of the functions or methods discussed herein. The instructions 902 configure a general, non-programmed machine into a particular machine 900 programmed to carry out said functions and/or methods.

In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a set-top box (STB), a PDA, an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 902, sequentially or otherwise, that specify actions to be taken by the machine 900. Further, while only a single machine 900 is depicted, the term “machine” shall also be taken to include a collection of machines that individually or jointly execute the instructions 902 to perform any one or more of the methodologies or subsets thereof discussed herein.

The machine 900 may include processors 904, memory 906, and I/O components 908, which may be configured to communicate with each other such as via one or more bus 910. In an example embodiment, the processors 904 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, one or more processor (e.g., processor 912 and processor 914) to execute the instructions 902. The term “processor” is intended to include multi-core processors that may comprise two or more independent processors (sometimes referred to as “cores”) that may execute instructions contemporaneously. Although FIG. 9 depicts multiple processors 904, the machine 900 may include a single processor with a single core, a single processor with multiple cores (e.g., a multi-core processor), multiple processors with a single core, multiple processors with multiples cores, or any combination thereof.

The memory 906 may include one or more of a main memory 916, a static memory 918, and a storage unit 920, each accessible to the processors 904 such as via the bus 910. The main memory 916, the static memory 918, and storage unit 920 may be utilized, individually or in combination, to store the instructions 902 embodying any one or more of the functionality described herein. The instructions 902 may reside, completely or partially, within the main memory 916, within the static memory 918, within a machine-readable medium 922 within the storage unit 920, within at least one of the processors 904 (e.g., within the processor's cache memory), or any suitable combination thereof, during execution thereof by the machine 900.

The I/O components 908 may include a wide variety of components to receive input, provide output, produce output, transmit information, exchange information, capture measurements, and so on. The specific I/O components 908 that are included in a particular machine will depend on the type of machine. For example, portable machines such as mobile phones will likely include a touch input device or other such input mechanisms, while a headless server machine will likely not include such a touch input device. It will be appreciated that the I/O components 908 may include many other components that are not shown in FIG. 9. The I/O components 908 are grouped according to functionality merely for simplifying the following discussion and the grouping is in no way limiting. In various example embodiments, the I/O components 908 may include output components 924 and input components 926. The output components 924 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 926 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), one or more cameras for capturing still images and video, and the like.

In further example embodiments, the I/O components 908 may include biometric components 928, motion components 930, environmental components 932, or position components 934, among a wide array of possibilities. For example, the biometric components 928 may include components to detect expressions (e.g., hand expressions, facial expressions, vocal expressions, body gestures, or eye tracking), measure bio-signals (e.g., blood pressure, heart rate, body temperature, perspiration, or brain waves), identify a person (e.g., voice identification, retinal identification, facial identification, fingerprint identification, or electroencephalogram-based identification), and the like. The motion components 930 may include acceleration sensor components (e.g., accelerometer), gravitation sensor components, rotation sensor components (e.g., gyroscope), and so forth. The environmental components 932 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 934 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 908 may include communication components 936 operable to couple the machine 900 to a network 938 or devices 940 via a coupling 942 and a coupling 944, respectively. For example, the communication components 936 may include a network interface component or another suitable device to interface with the network 938. In further examples, the communication components 936 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 940 may be another machine or any of a wide variety of peripheral devices (e.g., a peripheral device coupled via a USB).

Moreover, the communication components 936 may detect identifiers or include components operable to detect identifiers. For example, the communication components 936 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 936, such as location via Internet Protocol (IP) geolocation, location via Wi-Fi® signal triangulation, location via detecting an NFC beacon signal that may indicate a particular location, and so forth.

The various memories (i.e., memory 906, main memory 916, static memory 918, and/or memory of the processors 904) and/or storage unit 920 may store one or more sets of instructions and data structures (e.g., software) embodying or utilized by any one or more of the methodologies or functions described herein. These instructions (e.g., the instructions 902), when executed by processors 904, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors and internal or external to computer systems. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such intangible media, at least some of which are covered under the term “signal medium” discussed below.

Some aspects of the described subject matter may in some embodiments be implemented as computer code or machine-useable instructions, including computer-executable instructions such as program modules, being executed by a computer or other machine, such as a personal data assistant or other handheld device. Generally, program modules including routines, programs, objects, components, data structures, etc., refer to code that performs particular tasks or implement particular data structures in memory. The subject matter of this application may be practiced in a variety of system configurations, including hand-held devices, consumer electronics, general-purpose computers, more specialty computing devices, etc. The subject matter may also be practiced in distributed computing environments where tasks are performed by remote-processing devices that are linked through a communications network.

In various example embodiments, one or more portions of the network 938 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 938 or a portion of the network 938 may include a wireless or cellular network, and the coupling 942 may be a Code Division Multiple Access (CDMA) connection, a Global System for Mobile communications (GSM) connection, or another type of cellular or wireless coupling. In this example, the coupling 942 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 902 and/or data generated by or received and processed by the instructions 902 may be transmitted or received over the network 938 using a transmission medium via a network interface device (e.g., a network interface component included in the communication components 936) and utilizing any one of a number of well-known transfer protocols (e.g., hypertext transfer protocol (HTTP)). Similarly, the instructions 902 may be transmitted or received using a transmission medium via the coupling 944 (e.g., a peer-to-peer coupling) to the devices 940. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 902 for execution by the machine 900, and/or data generated by execution of the instructions 902, and/or data to be operated on during execution of the instructions 902, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

Enabling procedural guidance systems to understand the environment or work space from camera images may require a means to determine the position and pose of objects in the environment. For example, it may prove necessary to position augmented reality action cues on individual wells the operator's view of an identified and segmented 96-well plate. In such plates, wells are in 8 rows of 12 columns, and well centers are 9 mm apart. To be able to place action cues accurately, a novel fast algorithm for computing the 3D position and orientation of rectangular objects of known dimensions may be utilized.

This algorithm algebraically combines the image locations of plate corners, from a calibrated camera, and computes the locations of the corners as they are positioned within a 3D camera-fixed frame. From these locations it generates a transformation, from a standard orientation and position in which the corner and well locations are known, to the orientation and position recorded by the camera. It then uses that same transformation to project an augmented reality cue such as a well-centered marker into the human operator's field of view (FoV). The transformation logic is readily extended to learn position and orientation of other objects of known dimensions and shapes and properly project markers corresponding to locations on the surface into the operator's FoV.

### LISTING OF DRAWING ELEMENTS

102 environment of interest
104 human operator
106 augmented reality headset
108 physical object
110 augmented reality environment
112 physical object depiction
114 augmentation
116 augmented camera
118 physical workspace
120 superimposing logic
122 images or video
200 augmented reality system
202 augmented reality environment
204 operator
206 virtual object
208 physical workspace depiction
210 application
212 operating system
214 hardware
302 human operator
304 augmented reality device
306 procedural guidance logic
308 knowledge base
310 structured knowledge representation
312 machine learning logic
314 trainers
402 block
404 block
406 block
408 block
602 shrinker image augmentation
604 clumping image augmentation
606 photobomb image augmentation
608 synthetic photobomb image augmentation
610 mover image augmentation
612 shaker image augmentation
614 training set
702 image
704 object
706 bounding box
900 machine
902 instructions
904 processors
906 memory
908 I/O components
910 bus
912 processor
914 processor
916 main memory
918 static memory
920 storage unit
922 machine-readable medium
924 output components
926 input components
928 biometric components
930 motion components
932 environmental components
934 position components
936 communication components
938 network
940 devices
942 coupling
944 coupling

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the invention as claimed. The scope of inventive subject matter is not limited to the depicted embodiments but is rather set forth in the following Claims.

What is claimed is:

1. A method, comprising:
creating a training set for training a machine learning algorithm of a machine vision system that detects objects in an environment, the training set including multiple images of an object; and
applying one or more training set augmentations to each of a plurality of images included in the multiple images of the object to generate additional images that include the object for inclusion in the training set, wherein the one or more training set augmentations include an object motion augmentation, a camera motion augmentation, an object clumping augmentation, an object size reduction augmentation, a first diversified background augmentation, or a second diversified background augmentation with one or more synthetic background images.

2. The method of claim 1, wherein the applying the object motion augmentation or the camera motion augmentation to generate an additional image that includes the object comprises blurring images pixel of an image that comprises the object.

3. The method of claim 1, wherein the applying the object clumping augmentation to generate an additional image that includes the object comprises:
assigning objects in various images of the objects to a random sequence, the various images including an image of the object; and
moving each successive object of the random sequence other than a first object in the random sequence one at a time along a line that joins a corresponding centroid of each successive object to a centroid of the first object until each successive object makes contact with any preceding object in the random sequence.

4. The method of claim 1, wherein the applying the object size reduction augmentation to generate an additional image that includes the object comprises:
shrinking the object that is in an image within boundaries of an image segment that the object occupied in the image; and
filling vacated space in the image segment that results from the shrinking of the object with shrunken background image information.

5. The method of claim 1, wherein the applying the first diversified background augmentation to generate an additional image that includes the object comprises inserting image pixels in an image that corresponds to the object into the additional image that includes background clutter.

6. The method of claim 1, wherein the applying the second diversified background augmentation to generate an additional image that includes the object comprises:
generating at least one synthetic image of the object based on a 3D coordinate model of the object; and
applying game physics to the at least one synthetic image to place the object in a physically realist way into a background image that comprises one or more other objects that are relevant to the object.

7. The method of claim 1, wherein the creating the training set includes:
capturing the multiple images of the object using at least one of a variety of different cameras, different camera angles, different distances of the different cameras from the object, different light conditions, and different image backgrounds;
labeling the object as captured in the multiple images with corresponding labels by at least segmenting the object in each of the multiple images from a corresponding background based on an inputted polygon with a perimeter that corresponds to one or more boundaries of the object and associate the object that is segmented with a corresponding label;
annotating each of the multiple images with additional annotating information about the object;
compiling the multiple images of the object, the corresponding labels, and the additional annotation information into the training set for training the machine learning algorithm of the machine vision system.

8. The method of claim 7, wherein the corresponding label of the object in an image of the multiple images is a label from a structured knowledge representation, the structured knowledge representation includes labels that are members of multiple object classes.

9. The method of claim 1, wherein the machine vision system is used by an augmented reality procedural guidance system to guide an operator in completing one or more steps for one or more objects using an augmented reality environment.

10. The method of claim 1, wherein the machine learning algorithm includes a neural network.

11. The method of claim 1, further comprising:
training the machine vision system to recognize optically distinguishable markers; and
associating the optically distinguishable markers with particular objects in a knowledge base or a structured knowledge representation; and
recognizing, at least via the machine vision system, an additional object in the environment as a particular object based at least on an optically distinguishable marker that is affixed to the additional object and an association of the particular object with the optically distinguishable marker in the knowledge base or the structure knowledge representation.

12. The method of claim 11, wherein the optically distinguishable markers are generated by a generative cooperating network (GCN).

13. One or more non-transitory computer-readable media storing computer-executable instructions that upon execution cause one or more processors to perform acts comprising:
capturing multiple images of an object using at least one of a variety of different cameras, different camera angles, different distances of the different cameras from the object, different light conditions, and different image backgrounds;
labeling the object as captured in the multiple images with corresponding labels by at least segmenting the object in each of the multiple images from a corresponding background based on an inputted polygon with a perimeter that corresponds to one or more boundaries of the object and associates the object that is segmented with a corresponding label;
annotating each of the multiple images with additional annotating information about the object;
compiling the multiple images of the object, the corresponding labels, and the additional annotation information into a training set for training a machine learning algorithm of a machine vision system that detects objects in an environment.

14. The one or more non-transitory computer-readable media of claim 13, wherein the acts further comprise applying one or more training set augmentations to each of a plurality of images included in the multiple images of the object to generate additional images that include the object for inclusion in the training set, wherein the one or more training set augmentations include an object motion augmentation, a camera motion augmentation, an object clumping augmentation, an object size reduction augmentation, a first diversified background augmentation, or a second diversified background augmentation with one or more synthetic background images.

15. The one or more non-transitory computer-readable media of claim 13, wherein the machine vision system is used by an augmented reality procedural guidance system to guide an operator in completing one or more steps for one or more objects using an augmented reality environment.

16. The one or more non-transitory computer-readable media of claim 13, wherein the acts further comprising:
training the machine vision system to recognize optically distinguishable markers; and
associating the optically distinguishable markers with particular objects in a knowledge base or a structured knowledge representation; and
recognizing, at least via the machine vision system, an additional object in the environment as a particular object based on an optically distinguishable marker that is affixed to the additional object and an association of the particular object with the optically distinguishable marker in the knowledge base or the structure knowledge representation.

17. A method, comprising:
training a machine vision system to recognize optically distinguishable markers; and
associating the optically distinguishable markers with particular objects in a knowledge base or a structured knowledge representation; and
recognizing, at least via the machine vision system, an object in an environment as a particular object based at least on an optically distinguishable marker that is affixed to the object and an association of the particular object with the optically distinguishable marker in the knowledge base or the structure knowledge representation.

18. The method of claim 17, wherein the optically distinguishable markers are generated by a generative cooperating network (GCN).

19. The method of claim 17, further comprising:
creating a training set for training the machine learning algorithm of the machine vision system to detect objects in the environment, the training set including multiple images of an additional object;
applying one or more training set augmentations to each of a plurality of images included in the multiple images of the object to generate additional images that include the object for inclusion in the training set, wherein the one or more training set augmentations include an object motion augmentation, a camera motion augmentation, an object clumping augmentation, an object size reduction augmentation, a first diversified background augmentation, or a second diversified background augmentation with one or more synthetic background images.

20. The method of claim 17, wherein the machine vision system is used by an augmented reality procedural guidance system to guide an operator in completing one or more steps for one or more objects using an augmented reality environment.
